(19) United States
(12) Patent Application Publication
(10) Pub. No.: US 2013/0219197 A1
(43) Pub. Date: Aug. 22, 2013

(54) REMOTE POWER MANAGEMENT SYSTEM AND METHOD

(71) Applicants: Jum Han Lee, Yongin-si (KR); Yo Min Lee, Seoul (KR)

(72) Inventors: Jum Han Lee, Yongin-si (KR); Yo Min Lee, Seoul (KR)

(21) Appl. No.: 13/879,048

(22) PCT Filed: Jun. 9, 2011
(86) PCT No.: PCT/KR2011/004243

§ 371 Date: Apr. 12, 2013

(30) Foreign Application Priority Data
Oct. 14, 2010 (KR) 10 2010 0100275

(51) Int. Cl. G06F 1/26

(52) U.S. Cl. CPC G06F 1/26
USPC 713/300

(57) ABSTRACT

The present invention relates to a power management system and method, and more specifically, to a power management system and method, wherein: access information of a termination device, which is coupled with a target terminal together with a sharer, and access information of the target terminal are stored and managed in a relay server; and said relay server provides the access information of the target terminal to said termination device if a client performs an on/off control for the power of said target terminal power from a remote place, so that said termination device is capable of performing the power on/off control for the target terminal.

### TECHNICAL FIELD

The present invention relates to a power management system and method, and more particularly, to a power management system and method, wherein access information of a target terminal and a termination device such as a sharer connected to the target terminal is stored and managed by a relay server, and the relay server provides the access information of the target terminal to the termination device when a remote client performs power on/off control for the target terminal, thereby allowing the termination device to perform the power on/off control for the target terminal.

### BACKGROUND ART

In general, Wake-on-Local Area Network (WOl) technology using a LAN line has been employed as a configuration for remotely turning on a target terminal.

In the WOL configuration, when a LAN line is connected to the target terminal even in the case where the target terminal is off, wake up information (a magic packet) for turning on a target terminal is remotely transmitted to a LAN card mounted on a main card through a LAN, and the main board of the target terminal operates to turn on the target terminal in response to the wake up information received from the LAN card.

However, such a conventional WOL configuration has a problem in that Internet protocol (IP) information is needed because the IP information of the target terminal must be directly input for setup, and setup operation is not easy for a user.

In addition, when the target terminal uses a static IP, remote power management is permitted. However, when the target terminal uses a private IP or a dynamic IP, remote power management is permitted since an address of the target terminal cannot be specified.

### DISCLOSURE

### Technical Problem

Therefore, the present invention is conceived to solve the forgoing problems, and an aspect of the present invention is to provide a remote power management system, wherein access information of a target terminal and a termination device such as a sharer connected to the target terminal is previously registered such that remote power management is permitted even in the case where the target terminal uses a private IP or a dynamic IP.

### Technical Solution

In accordance with one aspect of the present invention, a remote power management system includes: an access information setup unit that transmits access information of a target terminal and a termination device connected to the target terminal; and a power management unit that stores and manages the access information of the target terminal and the termination device, and transmits a turn on/off command for the target terminal to remotely control power of the target terminal.

The access information setup unit may include: a setup application that is installed in the target terminal, obtains the access information of the target terminal and the termination device connected to the target terminal, and transmits the access information of the target terminal and the termination device to a relay server through the termination device; and a termination device that transmits the access information obtained through communication with the setup application to the relay server.

The setup application obtains the access information by automatically extracting the access information of the target terminal and the sharer.

The power management unit may include: a database which receives, stores and manages the access information of the target terminal and the termination device set through the access information setup unit from the termination device; a power management section which extracts the access information stored in the database when a viewer terminal requests power management of the target terminal and transmits a power control signal (on/off command) to the termination device; and a viewer application that is installed in the viewer terminal and sets up the power control signal in the power management section.

The database may include: a first database included in the relay server and storing sharer access information mapped to identification information of a client; and a second database included in the termination device and storing target terminal access information mapped to the identification information of the client.

The power management section may include: an access information registration module that maps the access information received from the access information setup unit of the target terminal to identification information of a client and stores the mapped information in the database; and a remote power management module that allows access of a remote viewer terminal, authenticates a client with identification information when power management for the target terminal is requested, extracts the access information of the termination device and the target terminal mapped to the identification information from the database when the client is authenticated, and transmits the power control command to the target terminal through the termination device.

The access information registration module may be included in the relay server; and the remote power management module may be included in the termination device.

The access information of the target terminal may include an Internet protocol (IP) address, a domain name, or a MAC address, and the termination device access information may include an IP address or domain name of the termination device.

The termination device may include a sharer.

In accordance with another aspect of the present invention, a remote power management method includes: registering access information of a target terminal and termination device with a relay server; transmitting a power control command to the target terminal when power management for the registered target terminal is requested; and controlling power of the target terminal in response to the power control command.

The registering may include: activating a setup application of the target terminal to extract the access information of the target terminal and obtain the access information of the termination device; and transmitting the obtained access information of the target terminal and the termination device to the relay server, and mapping, by an access information setup module of the relay server, identification information of a client to the access information of the target terminal and the termination device to store the mapped information in a database.

The registering may include: activating a setup application of the target terminal to extract the access information of the target terminal and obtain the access information of the termination device; transmitting the obtained access information of the termination device to the relay server, and mapping, by an access information setup module of the relay server, the identification information of a client to the access information of the termination device to store the mapped information in a first database; and mapping the identification information of the client to the access information of the target terminal to store the mapped information in a second database of the termination device.

The transmitting a power control command may include: activating a viewer application of a viewer terminal to specify the target terminal and provide an interface for selecting the power control command; transmitting identification information of a client and the power control command input through the interface to the relay server; and by a remote power management module of the relay server, authenticating the identification information, specifying the target terminal by extracting the access information of the target terminal and the termination device mapped to the identification information from a database, and transmitting the power control command to the target terminal through the termination device.

The transmitting a power control command may include: activating a viewer application of a viewer terminal to specify the target terminal and provide an interface for selecting the power control command; transmitting the identification information of a client and the power control command input through the interface to the relay server; by the relay server, authenticating the identification information, extracting the termination device access information mapped to the identification information from a first database, and transmitting the power control command together with the identification information to the termination device; and by the termination device, specifying the target terminal by extracting target terminal access information mapped to the identification information from a second database, and transmitting the power control command to the target terminal.

The transmitting the identification information and a power control command to the relay server may include: by a viewer application, transmitting the identification information to the relay server and requesting power state information of the target terminal; by a remote power management module of the relay server, authenticating the identification information and extracting the access information of the target terminal and the termination device mapped to the identification information from the database; transmitting the access information of the target terminal based on the extracted access information of the termination device to request the power state information of the target terminal from the termination device; and by the termination device, specifying the target terminal with the access information of the target terminal, checking a power state of the target terminal, and transmitting the checked power state information to the viewer application through the relay server.

The transmitting the identification information and a power control command to the relay server may include: by a viewer application, transmitting the identification information to the relay server and requesting power state information of a target terminal; by the relay server, authenticating the identification information and extracting the termination device access information mapped to the identification information from a first database; requesting the power state information of the target terminal, together with the identification information, from the termination device specified with the extracted termination device access information; and by the termination device, specifying the target terminal by extracting the access information of the target terminal mapped to the identification information from a second database, checking a power state of the target terminal, and transmitting the checked power state information to the viewer application through the relay server.

The checking the power state of the target terminal may include: by the termination device, transmitting a response signal to the target terminal based on the access information of the target terminal, and determining the power state to be a power-off state when there is no response, and the power state to be a power-on state when there is a response.

The transmitting a power control command may include by the termination device, specifying the target terminal based on the access information of the target terminal, and transmitting a power control signal through a LAN line connected to the target terminal; and by a main board of the target terminal, turning the target terminal on or off in response to the power control signal.

### Advantageous Effects

As described above, in the remote power management system and method according to embodiments of the invention, access information of a target terminal and a termination device is registered and managed by a relay server, thereby providing beneficial effects of enabling remote power control even in the case where an IP address of the target terminal is a private IP or a static IP.

In addition, in the remote power management system and method according to embodiments of the invention, access information and identification information (ID, password) set up by a client are mapped and managed, whereby the target terminal can be sufficiently specified using only the identification information, thereby providing beneficial effects of allowing the client to remotely and easily control power of the target terminal.

Further, upon setting up access information, a setup application can automatically extract the access information from the target terminal and the termination device, thereby providing beneficial effects of facilitating setup operation.

### DESCRIPTION OF DRAWINGS

FIG. 1 is a schematic diagram of a remote power management system according to one exemplary embodiment of the invention.

FIG. 2 is a detailed block diagram of the remote power management system according to the exemplary embodiment of the invention, and FIG. 3 is a schematic flowchart of a remote power management method.

FIG. 4 is a detailed block diagram of a remote power management system according to a second embodiment of the invention, and FIG. 5 is a schematic flowchart of a remote power management method of the remote power management system of FIG. 4.

### BEST MODE

Exemplary embodiments of the invention will now be described with reference to the accompanying drawings.

A remote power management system according to one exemplary embodiment of the invention may include an access information setup unit that transmits access information of a target terminal and a termination device connected to the target terminal to a relay server, and a power management unit that stores and manages the access information of the target terminal and the termination device and controls power on/off of the target terminal.

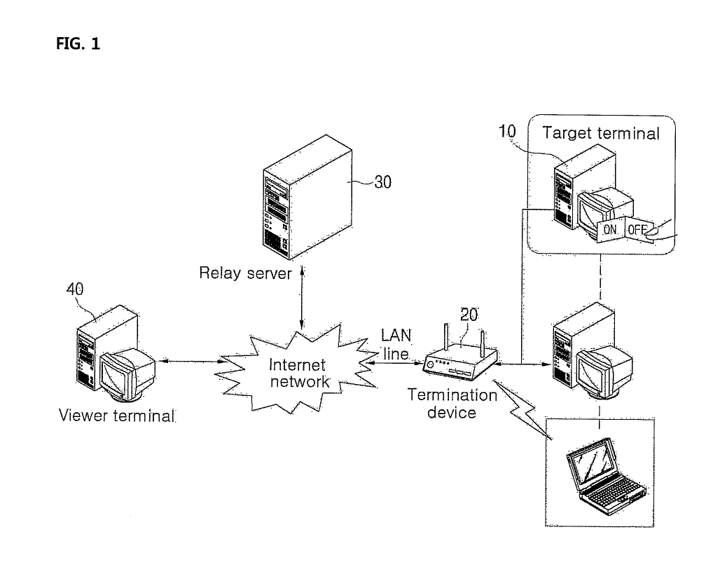

FIG. 1 is a schematic diagram of a remote power management system according to one exemplary embodiment of the invention.

Referring to FIG. 1, the access information setup unit may include a setup application 110 and a termination device 20. The setup application 110 is software installed in a target terminal 10, obtains access information of the target terminal and a termination device connected to the target terminal, and controls transmission of the access information to a relay server 30 through the termination device. The termination device 20 transmits the obtained access information to the relay server 30.

Here, the target terminal 10 refers to a terminal that is designated by a client as an object for power management in a viewer terminal, and the viewer terminal 40 refers to a terminal that is connected for remote control of the target terminal 10.

The target terminal 10 and the viewer terminal 40 may include any portable electronic devices capable of accessing the Internet as well as computer terminals such as personal computers (PC), notebook computers, etc.

Further, the termination device 20 refers to a device such as a sharer, hub, modem, etc., to which the target terminal 10 is connected for accessing the Internet.

Access information includes allocated IP address and media access control (MAC) address information, which is LAN card identification information, in the case of the target terminal 10, and includes IP information in the case of the termination device. Alternatively, domain information may be employed as the access information, instead of the IP information.

Further, the access information is mapped to identification (ID) information set up by a client and registered to the relay server 30.

Here, the identification information refers to information that allows a client to easily specify a target terminal and may include a combination of ID and passwords designated by a client.

The power management unit may include a database 320 which receives the access information of the target terminal 10 and the termination device 20 set up by the access information setup unit through the termination device 20 and stores and manages the access information, and a power management section 310 which extracts the access information stored in the database and transmits a power control signal to the corresponding termination device when the viewer terminal requests power management of the target terminal.

Here, the power management section 310 may include an access information registration module 311 that maps the access information of the target terminal and the termination device received from the termination device 20 to identification information set up by a client and registers and stores the mapped information in the database; and a remote power management module 312 that allows access of a remote viewer terminal, authenticates a client when a power control command for the target terminal is requested, extracts the stored access information of the termination device and the target terminal from the database when the client is authenticated, and transmits the power control command together with the access information of the target terminal to the termination device.

In addition, the power management unit may further include a viewer application installed in the viewer terminal so that a client can transmits a power on/off command for the target terminal to the remote power management module 312.

Next, a remote power management method according to one exemplary embodiment of the invention will be described.

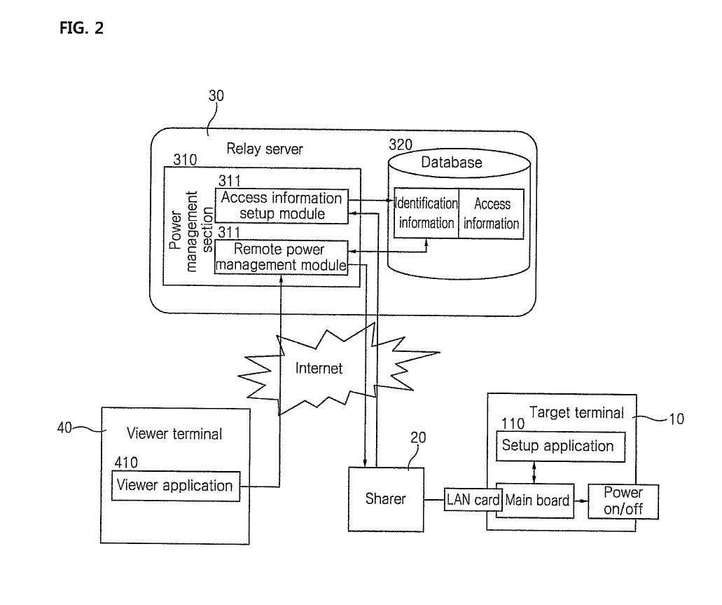

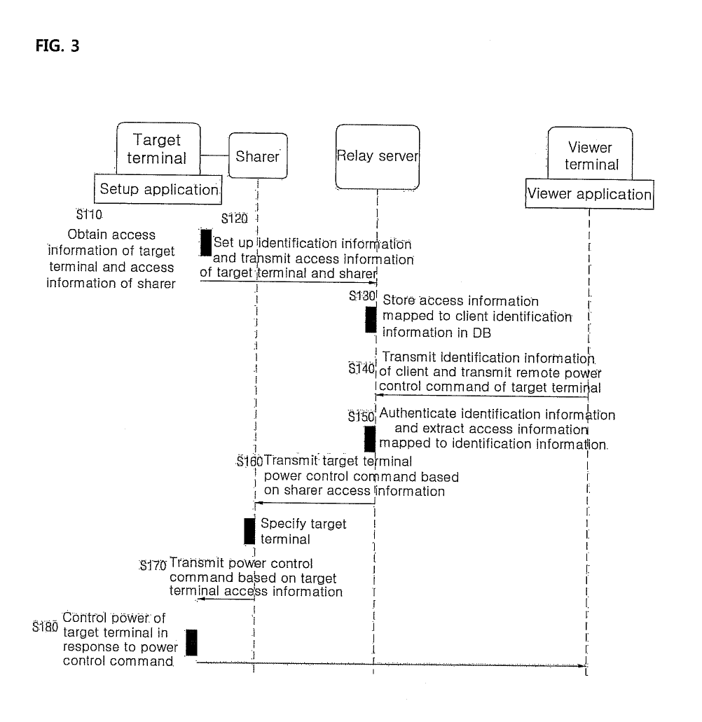

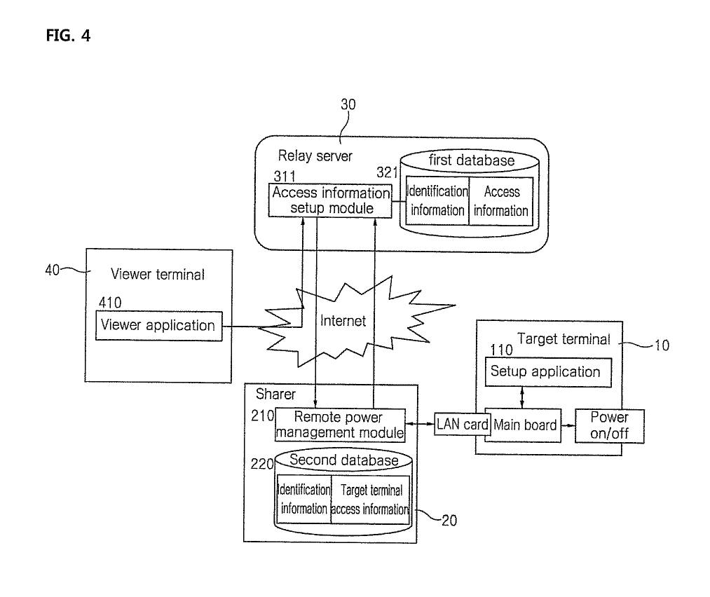

FIG. 2 is a detailed block diagram of the remote power management system according to a first embodiment of the invention, and FIG. 3 is a schematic flowchart of a remote power management method of the remote power management system of FIG. 2.

Although a sharer is illustrated as the termination device for convenience of description in this embodiment, it will be apparent that a hub, a modem, and the like may also be used as the termination device.

Referring to FIGS. 2 and 3, with a setup application installed in the target terminal, access information is obtained (S110).

Specifically, when the setup application 110 is installed and activated, sharer IP information about the sharer to which the target terminal is connected is extracted, and IP address and MAC address information of the target terminal is extracted, thereby obtaining the access information. The setup application 110 may be realized by allowing a client to directly input the sharer IP information, or by automatically extracting the IP information stored in the sharer for convenience of setup operation.

If the access information is obtained as described above, the setup application 110 accesses the relay server and provides an interface for setting up identification information in association with the access information setup module of the power management section.

The identification information of the client is set through the interface, and the obtained access information is transmitted to the relay server (S120).

Next, the access information setup module of the relay server stores and registers an access information table, in which the access information is mapped to the identification information as shown in the following table 1, in the database (S130).

TABLE 1

| | | Access | Access information of | |
|---|---|---|---|---|
| Identification | | information | target terminal | |
| information | | of sharer | | MAC |
| ID | Password | Sharer IP | Target terminal IP | address |
| ABC | **** | 211.111.XXX.XXX | 192.168.XXX.XXX | xx-xx- |
| | | | | xx-xx- |
| | | | | xx-xx |

Though this operation, when a client remotely inputs only identification information (ID, password) of the client, the access information of the target terminal is extracted whereby a power source of the target terminal can be remotely controlled.

If the access information of the sharer or the target terminal, for example, the IP address is changed, the changed information is transmitted to the relay server such that the access information can be updated.

Next, a client installs a viewer application 410, which provides an interface for power management of the target terminal, in the viewer terminal 40.

Here, the viewer application 410 serves not only to access the relay server 30 and specify the target terminal 10 based on the identification information input by a client, but also to display a power on/off state of the target terminal from the power management section 310 of the relay server.

The viewer application 410 may be directly downloaded and installed from the relay server 30, but is not limited thereto. Alternatively, the viewer application may be downloaded from a separate external server, or installed via a portable storage medium.

If the viewer application 410 is installed and a client tries to control the power of the target terminal, the viewer application is activated and the identification information (ID, password) and a power control command are input through the interface provided by the viewer application and transmitted to the relay server 30 (S140).

When the relay server 30 receives the identification information from the viewer application, the remote power management module 312 of the power management section determines whether the identification information matches the identification information stored in the database 320 to authenticate a client, and extracts the access information of the sharer and the target terminal mapped to the identification information when the client is authenticated (S 150).

Although the identification information and the power control command are illustrated as being simultaneously transmitted to the relay server 30 in this embodiment, the invention is not limited thereto. Alternatively, the power control command may be transmitted after the identification information is successfully authenticated in accordance with interface configuration.

Next, the power control command, together with the access information (including IP address and MAC address) of the target terminal, is transmitted to the IP address of the sharer 20 included in the access information (S160).

Further, the sharer 20 specifies the target terminal 10 based on the access information of the target terminal and transmits the power control command to the IP address of the target terminal 10 (S170).

Next, the target terminal 10 controls the power source of the target terminal in response to the power control command (S180).

In more detail, when the power control command is a turn-on command for turning on the target terminal 10, the turn-on command (magic packet) may be transmitted to a LAN card through a LAN line since the target terminal 10 is connected to the sharer even though the target terminal 10 is turned off.

Thus, the sharer 20 transmits the turn-on command to the LAN card of the target terminal 10, and a main board connected to the LAN card turns on the target terminal in response to the turn-on command. Accordingly, it is possible to remotely turn on the target terminal.

On the other hand, when the power control command is a turn-off command for turning off the target terminal, the turn-off command is transmitted to the target terminal by the same procedure as the turn-on command. Accordingly, it is possible to remotely turn off the target terminal.

Here, the turn-on command or the turn-off command refers to packet information (magic packet) for turning on or off the target terminal.

When a client selects a current power state display menu of the target terminal through a viewer application, the identification information is received and transmitted to the relay server and the power management module of the relay server authenticates the identification information, thereby extracting the target terminal and the sharer access information mapped to the identification information when the client is authenticated.

Then, the power management module transmits a power state check command together with the access information of the target terminal to the sharer based on the access information of the sharer.

Further, the sharer receives the access information of the target terminal, and extracts the IP address and the MAC address from the access information, thereby specifying the target terminal connected thereto and checking the power state of the target terminal through a LAN line connected to the target terminal.

Here, when there is no response from the target terminal, it is recognized that the target terminal is turned off. On the other hand, when there is a response from the target terminal, it recognized that the target terminal is turned on and it is thus possible to check the power state of the target terminal.

After checking the power state of the target terminal, the sharer transmits the power state information to the relay server and the remote power management module of the relay server provides the power state information to the viewer application of the viewer terminal, whereby the viewer application can display the power state of the target terminal on the viewer terminal.

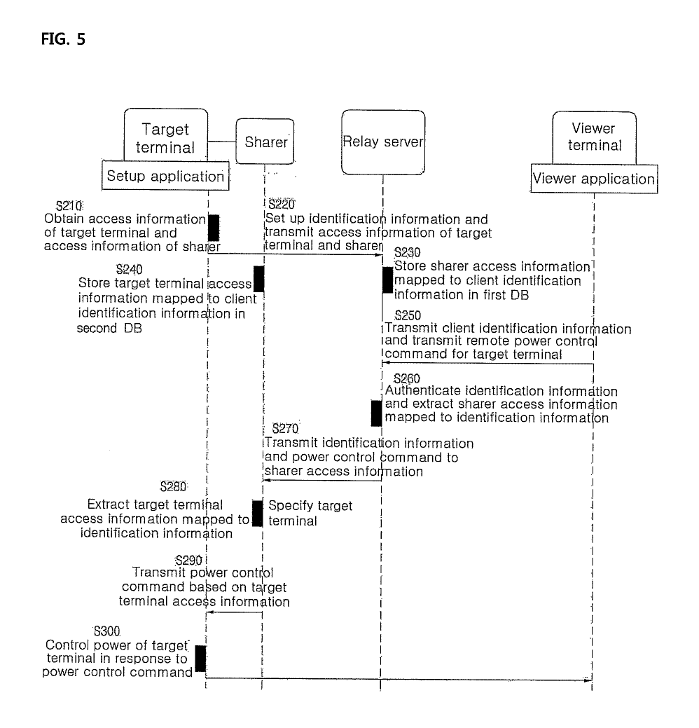

FIG. 4 is a detailed block diagram of a remote power management system according to a second embodiment of the invention, and FIG. 5 is a schematic flowchart of a remote power management method of the remote power management system of FIG. 4.

The system of the second embodiment is the same as that of the first embodiment except that the remote power management module of the power management section in the relay server is provided to the sharer, and the database is divided into a first database and a second database, which is placed in the sharer. Repeated descriptions thereof will be omitted.

Referring to FIGS. 4 and 5, with a setup application installed in a target terminal, access information of the target terminal is obtained (S210).

Specifically, when the setup application 110 is installed and activated, sharer IP information about the sharer to which the target terminal is connected is extracted, and IP address and MAC address information of the target terminal are extracted, thereby obtaining the access information.

If the access information is obtained as described above, the setup application 110 accesses the relay server through the sharer and provides an interface for setting up the identification information in association with the access information setup module 311 of the relay server.

The identification information of the client is set through the interface, and the sharer access information of the obtained access information is transmitted to the relay server (S220).

Next, the access information setup module of the relay server stores and registers an access information table, in which the sharer access information is mapped to the identification information as shown in the following table 2, in the first database 321 (S230).

TABLE 2

| | |
|---|---|
| Identification information | Access information of sharer |

| ID | Password | Sharer IP |
|---|---|---|
| ABC | **** | 211.111.XXX.XXX |

Further, the sharer 20 receives the identification information (except for the password) from the relay server, maps the access information of the target terminal to the identification information as shown in the following table 3, and stores the mapped information in the second database 220 (S240).

TABLE 3

| Identification information | Access information of target terminal | |
|---|---|---|
| ID | Target terminal IP | MAC address |
| ABC | 192.168.XXX.XXX | xx-xx-xx-xx-xx-xx |

Though this operation, when a client remotely inputs only identification information (ID, password) of the client, the access information of the target terminal is extracted whereby a power source of the target terminal can be remotely controlled.

If the access information of the sharer or the target terminal, for example, the IP address, is changed, the changed information is transmitted to the relay server or the sharer such that the access information can be updated.

Next, a client installs a viewer application 410, which provides an interface for power management of the target terminal, in the viewer terminal 40.

If the viewer application 410 is installed and a client tries to control the power of the target terminal, the viewer application is activated and the identification information (ID, password) and a power control command are input through the interface provided by the viewer application and transmitted to the relay server 30 (S250).

Upon receiving the identification information from the viewer application, the relay server 30 determines whether the identification information matches the identification information stored in the database 320 to authenticate a client, and extracts the access information of the sharer mapped to the identification information when the client is authenticated (S260).

Although the identification information and the power control command are illustrated as being simultaneously transmitted to the relay server 30, the invention is not limited thereto. Alternatively, the power control command may be transmitted after the identification information is successfully authenticated in accordance with interface configuration.

Next, the power control command, together with the identification information of a client, is transmitted to the IP address of the sharer 20 included in the access information of the sharer (S270).

The remote power management module 210 of the sharer 20 extracts the access information of the target terminal mapped to the identification information from the second database to specify the target terminal 10 (S280), and transmits the power control command to the IP address of the target terminal 10 (S290).

Next, the target terminal 10 controls the power source of the target terminal in response to the power control command (S300).

Although some embodiments have been described herein, it will be understood by those skilled in the art that these embodiments are provided for illustration only, and various modifications, changes, alterations and equivalent embodiments can be made without departing from the scope of the present invention. Therefore, the scope and sprit of the present invention should be defined only by the claims and equivalents thereof.

1. A remote power management system comprising:
an access information setup unit that transmits access information of a target terminal and a termination device connected to the target terminal; and
a power management unit that stores and manages the access information of the target terminal and the termination device, and transmits a turn on/off command for the target terminal to remotely control power of the target terminal.

2. The remote power management system according to claim 1, wherein the access information setup unit comprises:
a setup application that is installed in the target terminal, obtains the access information of the target terminal and the termination device connected to the target terminal, and transmits the access info nation of the target terminal and the termination device to a relay server through the termination device; and
a termination device that transmits the access information obtained through communication with the setup application to the relay server.

3. The remote power management system according to claim 2, wherein the setup application obtains the access information by automatically extracting the access information of the target terminal and the sharer.

4. The remote power management system according to claim 1, wherein the power management unit comprises:
a database which receives, stores and manages the access information of the target terminal and the termination device set through the access information setup unit from the termination device;
a power management section which extracts the access information stored in the database when a viewer terminal requests power management of the target terminal and transmits a power control signal (on/off command) to the termination device; and
a viewer application that is installed in the viewer terminal and sets up the power control signal in the power management section.

5. The remote power management system according to claim 4, wherein the database comprises:
a first database included in the relay server and storing sharer access information mapped to identification information of a client; and
a second database included in the termination device and storing target terminal access information mapped to the identification information of the client.

6. The remote power management system according to claim 4, wherein the power management section comprises:
an access information registration module that maps the access information received from the access information setup unit of the target terminal to identification information of a client and stores the mapped information in the database; and
a remote power management module that allows access of a remote viewer terminal, authenticates a client with identification information when power management for the target terminal is requested, extracts the access information of the termination device and the target terminal mapped to the identification information from the database when the client is authenticated, and transmits the power control command to the target terminal through the termination device.

7. The remote power management system according to claim. 6, wherein the access information registration module is included in the relay server; and the remote power management module is included in the termination device.

8. The remote power management system according to claim 1, wherein the access information of the target terminal comprises an Internet protocol (IP) address, a domain name, or a MAC address, and the termination device access information comprises an IP address or domain name of the termination device.

9. The remote power management system according to claim 1, wherein the termination device comprises a sharer.

10. A remote power management method comprising:
registering access information of a target terminal and a termination device with a relay server;
transmitting a power control command to the target terminal when power management for the registered target terminal is requested; and
controlling power of the target terminal in response to the power control command.

11. The remote power management method according to claim 10, wherein the registering comprises:
activating a setup application of the target terminal to extract the access information of the target terminal and obtain the access information of the termination device; and
transmitting the obtained access information of the target terminal and the termination device to the relay server, and mapping, by an access information setup module of the relay server, identification information of a client to the access information of the target terminal and the termination device to store the mapped information in a database.

12. The remote power management method according to claim 10, wherein the registering comprises:
activating a setup application of the target terminal to extract the access information of the target terminal and obtain the access information of the termination device;
transmitting the obtained access information of the termination device to the relay server, and mapping, by an access info nation setup module of the relay server, the identification information of a client to the access information of the termination device to store the mapped information in a first database; and
mapping the identification information of the client to the access information of the target terminal to store the mapped info nation in a second database of the termination device.

13. The remote power management method according to claim 10, wherein the transmitting a power control command comprises:
activating a viewer application of a viewer terminal to specify the target terminal and provide an interface for selecting the power control command;
transmitting identification information of a client and the power control command input through the interface to the relay server; and
by a remote power management module of the relay server, authenticating the identification information, specifying the target terminal by extracting the access information of the target terminal and the termination device mapped to the identification information from a database, and transmitting the power control command to the target terminal through the termination device.

14. The remote power management method according to claim 10, wherein the transmitting a power control command comprises:
activating a viewer application of a viewer terminal to specify the target terminal and provide an interface for selecting the power control command;
transmitting the identification information of a client and the power control command input through the interface to the relay server;
by the relay server, authenticating the identification information, extracting the termination device access information mapped to the identification info nation from a first database, and transmitting the power control command together with the identification information to the termination device; and
by the termination device, specifying the target terminal by extracting target terminal access information mapped to the identification information from a second database, and transmitting the power control command to the target terminal.

15. The remote power management method according to claim 10, wherein the transmitting the identification information and a power control command to the relay server comprises:
by a viewer application, transmitting the identification information to the relay server and requesting power state information of the target terminal;
by a remote power management module of the relay server, authenticating the identification information and extracting the access information of the target terminal and the termination device mapped to the identification info nation from the database;
transmitting the access information of the target terminal based on the extracted access information of the termination device to request the power state information of the target terminal from the termination device; and
by the termination device, specifying the target terminal with the access information of the target terminal, checking a power state of the target terminal, and transmitting the checked power state information to the viewer application through the relay server.

16. The remote power management method according to claim 10, wherein the transmitting the identification information and a power control command to the relay server comprises:
by a viewer application, transmitting the identification information to the relay server and requesting power state information of a target terminal;
by the relay server, authenticating the identification information and extracting the termination device access information mapped to the identification information from a first database;
requesting the power state information of the target terminal, together with the identification information, from the termination device specified with the extracted termination device access information; and
by the termination device, specifying the target terminal by extracting the access information of the target terminal mapped to the identification information from a second database, checking a power state of the target terminal, and transmitting the checked power state information to the viewer application through the relay server.

17. The remote power management method according to claim 15, wherein the checking the power state of the target terminal comprises:
by the termination device, transmitting a response signal to the target terminal based on the access information of the target terminal, and determining the power state to be a power-off state when there is no response, and the power state to be a power-on state when there is a response.

18. The remote power management method according to claim 10, wherein the transmitting a power control command comprises;
by the termination device, specifying the target terminal based on the access information of the target terminal, and transmitting a power control through a LAN line connected to the target terminal; and
by a main board of the target terminal, turning the target terminal on or off in response to the power control signal.
